(19) United States
(12) Patent Application Publication
(10) Pub. No.: US 2006/0235965 A1
(43) Pub. Date: Oct. 19, 2006

(54) Method for quantifying the propensity to respond to an advertisement

(75) Inventors: Dominic V. Bennett, Los Altos, CA (US); Remigiusz K. Paczkowski, Belmont, CA (US)

Correspondence Address: CLARIA CORPORATION;c/o HAYNES BEFFEL & WOLFELD LLP, P.O. BOX 366, 751 KELLY STREET, HALF MOON BAY, CA, 94019, US

(73) Assignee: Claria Corporation, Redwood City, CA (US)

(21) Appl. No.: 11/369,334

(22) Filed: Mar. 7, 2006

Related U.S. Application Data
(60) Provisional application No. 60/659,682, filed on Mar. 7, 2005.

(51) Int. Cl. G06F 15/173

(52) U.S. Cl. 709/224

(57) ABSTRACT

A method of quantifying the propensity of a consumer to respond positively to an advertisement. The process begins by producing a set of training factors from the entire set of user data available, one set of such factors being associated with each advertisement under study to indicate the probability of positive response to that advertisement. Once the training phase is complete, the application phase begins by receiving input data from a user in real time. The process continues by applying the training factors to the user data to identify the advertisement having the highest probability of positive response and then displaying the identified advertisement to the user.

### RELATED APPLICATION

This application claims the benefit of U.S. Provisional Patent Application No. 60/659,682, entitled “Athena-Related Analytical Methods and Devices” filed on 07 Mar. 2005 by Mitchell Weisman, Craig Zeldin, David Goulden, Eric McKinlay and Dominic Bennett. That application is incorporated by reference for all purposes.

### BACKGROUND OF THE INVENTION

The present invention relates generally to the field of market research. In particular, it relates to the analysis of marketing data.

The science of economics is both complicated and inexact, precisely because human behavior is complex. While the question whether consumers will or will not respond to a particular advertisement by taking a desired action, generally purchasing or other wise, remains a matter governed more by intuition than science.

Market research as a discipline seeks to replace that intuition with objective judgments based on hard data, but to date that effort has not universally succeeded. Opinion pollsters are continually surprised by events, and multi-million dollar marketing campaigns completely fail.

A weakness of conventional marketing research is a lack of detailed information about actual consumer behavior leading up to a desired action. The fact needs no repetition that neither the general survey nor the focus group truly replicates consumer behavior. Rather, researchers need some method for knowing how real consumers behave in a real marketing setting.

The technique of gathering information about consumer behavior on the internet was set out in commonly-owned U.S. patent application Ser. No. 11/226,066, entitled “Method and Device for Publishing Cross-Network User Behavioral Data” filed on 14 Sep. 2005. (the “'066” application). That application is incorporated by reference herein for all purposes.

The technique of the '066 Application assists marketers in presenting content to users, but it does not set out an analytical foundation for determining exactly what advertisement will best meet the needs of a particular consumer.

The art stands in need of a better method for gathering and analyzing data. Better, more easily configured and controlled, more resilient and transparent components and systems may result.

### SUMMARY OF THE INVENTION

An aspect of the invention is a method of quantifying the propensity of a consumer to respond positively to an advertisement. The process begins by producing a set of training factors from the entire set of user data available, one set of such factors being associated with each advertisement under study to indicate the probability of positive response to that advertisement. Once the training phase is complete, the application phase begins by receiving input data from a user in real time. The process continues by applying the training factors to the user data to identify the advertisement having the highest probability of positive response and then displaying the identified advertisement to the user.

### BRIEF DESCRIPTION OF THE DRAWINGS

FIG. 1 illustrates the general process of an embodiment of the invention.

FIG. 2 illustrates a portion of the dataset prior to removing outlier data.

FIG. 3 illustrates a portion of the dataset after removing outlier data employed in an embodiment of the invention.

FIG. 4 illustrates the eigenvalue matrix employed in the initial factor analysis employed in the principal components analysis of an embodiment of the invention.

FIG. 5 illustrates the scree plot of the eigenvalue matrix employed in the principal components analysis of an embodiment of the invention.

FIG. 6 illustrates the initial factor pattern employed in the principal components analysis.

FIG. 7 illustrates the orthogonal transformation matrix employed in the principal components analysis of an embodiment of the invention.

FIG. 8 illustrates the rotated factor matrix produced by the principal components analysis of an embodiment of the invention.

FIG. 9 illustrates the results of the logistic regression employed by an embodiment of the invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

The key problem facing marketers can be stated as follows: What is the probability that a specific customer will respond positively to a particular advertisement? More particularly, the problem can be stated thusly: Given an inventory of existing advertisements, and given information about a consumers actual behavior, which advertisement has the highest probability of eliciting a positive response from the consumer?

Answering that question requires, first, that data regarding consumer behavior be gathered. Then, there must be provided a method for analyzing that data to relate it to the inventory of advertising material.

The first requirement is the topic of the '066 Application. As explained there, one method for gathering behavioral information about consumers is to monitor behavior directly as the user navigates on the internet, via behavior monitoring software resident on the user's computer. Behavior can be identified in terms of a subject-matter context, and information can also be gathered based on whether the user filled out forms on a page, or clicked on an advertisement. Such behavior records can be kept, summarized, and reported.

The present invention concerns the second requirement, a process for analyzing data to relate past behavior to specific situations to produce a prediction of future action. This involves dynamic statistical modeling, a process that automates the model building process. That process also requires two steps. First, data from past transactions must be analyzed to extract the relevant factors required for predicting whether a new user will or will not exhibit the desired behavior—here, clicking on an advertisement. That first phase is termed training, and it involves a detailed analysis of relevant past behavior. The output of the training phase is a set of factors, which can be applied to new data in the application phase, which produces results in real time.

It is important to note that the analytical training process must be carried out separately for each banner advertisement under consideration, as the factors to be produced will be different for each. Clearly, such research could not be carried on in real time, which requires careful preparation.

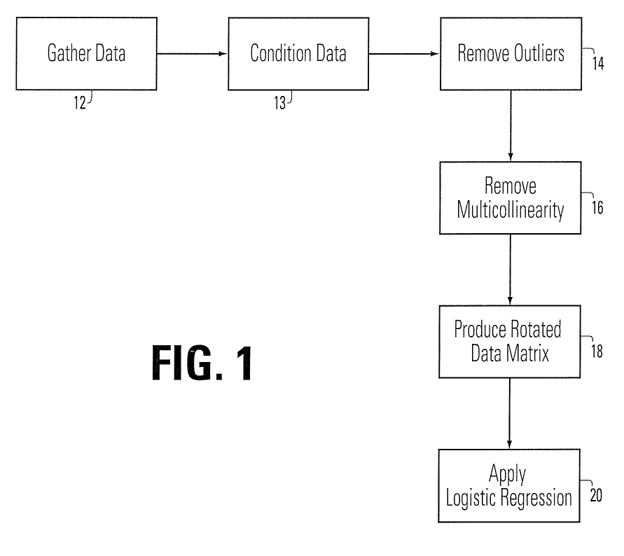

In general, the training process for each banner advertisement is depicted in FIG. 1. The discussion below addresses each of these steps in detail, so it will suffice at this point to cover a general overview of the procedure. As seen, the process starts with a data gathering step 12. Having this data, the analytical process proceeds separately for each banner advertisement under study. Data are first conditioned, in step 13, and outliers are removed, leaving a set of data that most likely reflects the reality of the marketplace, in step 14. Then the data is processed to remove multicollinearity in step 16, ensuring that variables are not mutually dependent. The rotation operation of step 18 establishes a set of orthogonal axes that maximize the variability of the data. Finally, step 20, performs a stepwise logistic regression to generate probabilities of events, namely user clicks on a presented advertisement.

While the present invention concerns general principles of consumer research, it will be helpful to consider an illustrative embodiment, based on the sorts of data gathered by the techniques of the '066 Application. As shown in Table 1, the behavior monitor can capture a subject field in which the user has been active, noted by the Category ID; a measure of how recent the activity was; a measure of how frequent the activity occurred; the number of times that a banner was clicked, and the ID of the banner.

TABLE 1
Data from User

| Category ID | Recency | Frequency | Banner Clicks |
|---|---|---|---|
| 10494 | 3 | 4 | 1 |
| 98409 | 1 | 6 | 4 |
| 65625 | 14 | 6 | 3 |

It will be clear to those in the art that each banner advertisement concerns a limited set of categories, which set will be different for each banner advertisement. Further, the data from the user does not include a critical piece of information—did that user click on a given banner. That data is available separately, with the user's machine ID, and thus that data can be included.

From all the data coming from users, combined with that from banner clicks, a dataset can be assembled for each banner ad, having the structure shown in Table 2, as follows:

TABLE 2
Analysis data input

Category 1 recency
Category 1 frequency
Category 2 recency
Category 2 frequency
. . .
Category 200 recency
Category 200 frequency
Banner ID
Number of impressions
Number of clicks
Counter

Note that the number of categories chosen for analysis is not the same number as the total categories available. Several thousand are available in total, but it will be understood that a much smaller number will be involved in any particular transaction event. The number of categories chosen can be varied, based on experience and desire for inclusiveness. Here, it was decided to include data for 200 categories.

The following discussion focuses on the analysis of the resulting user behavior data set. Analysis of the entire set requires consideration of 200 categories, each of which in turn has three dimensions—recency, frequency and number of users. Clearly, such an analysis could not be portrayed visually, and would make for lengthy and cumbersome explanation. Because processing and analysis proceeds identically for each category under consideration, the remaining discussion will examine in detail the process followed for a single category. It should be borne in mind that identical processing will occur for each of the selected 200 categories.

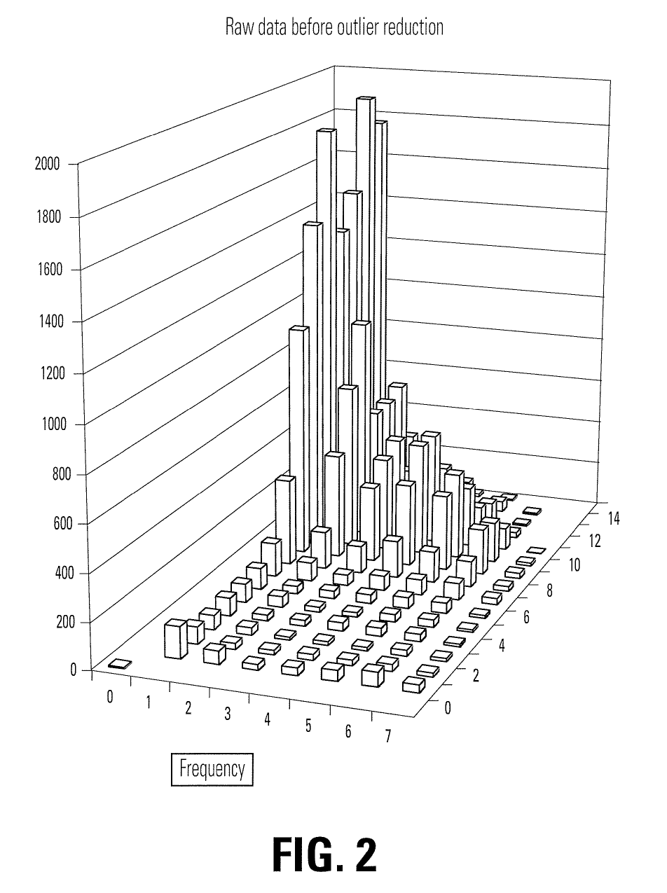

Typically, large volumes of data are available for processing in connection with such applications. In the example under discussion, the dataset for the single category consists of over 21,000 items. A plot of the dataset, with dimensions of frequency, recency and number of users, is shown in FIG. 2.

An important characteristic of this dataset is that it is clustered, rather than being evenly distributed over the space. This result is intuitive, as one would expect that the set of persons who clicked on a given banner ad would exhibit similar behaviors regarding a given category, and that expectation is borne out in practice. As seen, the data are strongly clustered in the area of low frequency but high recency values. It is therefore reasonable to expect that some form of regression analysis will produce useful results.

A first step in a regression analysis, however, is to eliminate outliers—data points that are clearly not participants in the phenomenon under study but which will tend to deflect a regression line, for example, from a true best fit to the data. It has been found that effective results are provided by a technique known as k-means clustering. In general, the objective of this process is to minimize intra-cluster variance. The process commences the partitioning the dataset into clusters, following a chosen heuristic, after which the centroid of each cluster is calculated. A new partition is then constructed by associating each point with the closest centroid, resulting in a new set of clusters. Through multiple iterations, the clusters converge. In the resulting set of clusters, some clusters will contain fewer data points than others—those points are outliers. A judgment is required regarding the level of clusters which can be discarded at the end of this operation. Here, clusters having only one or two points are discarded.

Of course, this process cannot reasonably be performed by hand. Most mathematical or statistical software packages contain such procedures, such as the FastClus procedure included as part of the SAS software package, offered by SAS Institute and well known by those in the art. Other mathematical and statistical software packages are available with the same functionality.

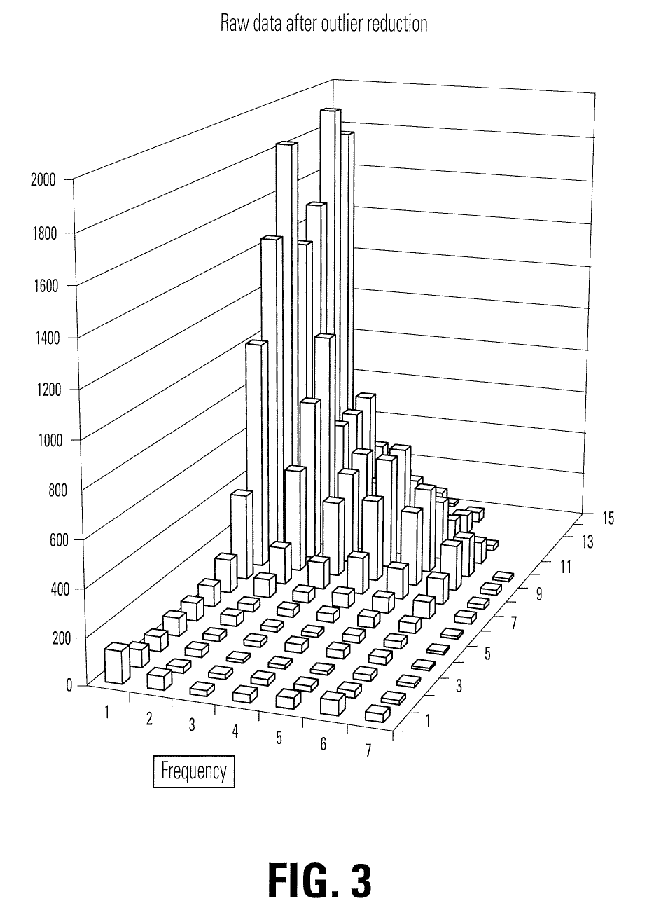

The results of this step are shown in FIG. 3, illustrating the dataset after removal of outliers. It should be noted that this step does not produce a radical change in the dataset. Rather, extreme values that would distort the regression analysis are removed, improving the reliability of future operations.

Having eliminated outliers, the issue arises whether the dimensions represented by the dataset are in fact independent. If, for example, one category exists aimed at “Travel” and another targets “Hotels”, one may suspect that a user who is active in both categories may be navigating to the latter because of something seen in the former, rather than from an independent motive. Counting such action twice would overrepresent those categories, contaminating the data. This problem, called multicollinearlity, requires that the dataset be transformed to a condition in which all dimensions are mutually orthogonal, so that activity in one dimension does not affect others. And such action must be taken in a way that preserves the original data.

A solution to that problem is the application of the statistical analysis procedure of principal component analysis. This procedure can be accomplished by the SAS software, employing the FACTOR procedure, as is known in the art. The goal of this procedure is to identify the underlying, unobservable variables that are reflected in the observed dataset. The process accepts the data matrix, free of outliers, as input, and it analyzes the correlations and variance among within the data to extract principal components. In doing so, it produces a matrix of eigenvectors, together with a corresponding set of eigenvalues.

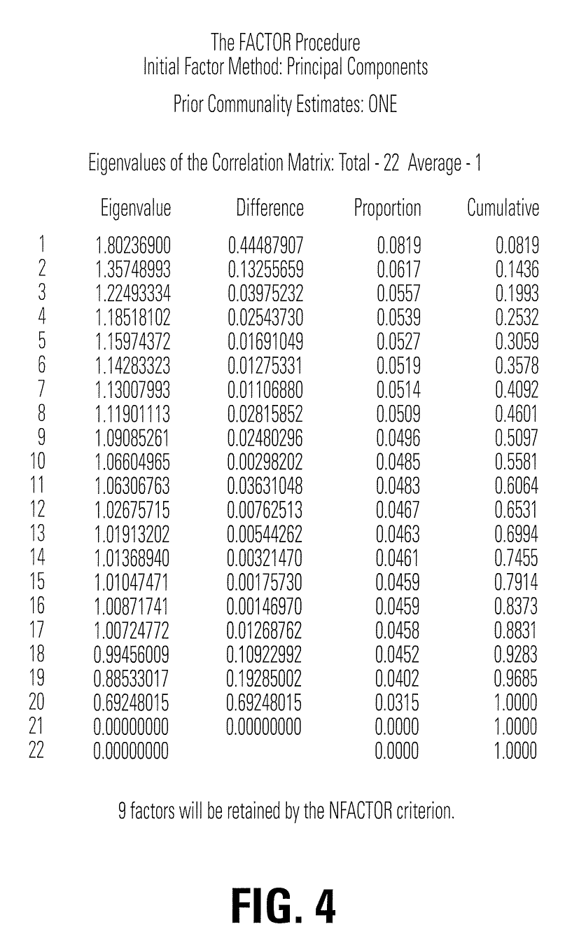

FIG. 4 illustrates the SAS FACTOR output for the first step of this process. The leftmost column is the set of eigenvalues. Each eigenvalue expresses the variance of one factor, or component. The “Difference” column notes the difference between the eigenvalue of that row and that of the next row down. “Proportion” shows what proportion of the total variance of the set is captured by the eigenvalue of that row. In the first row, for example, the first eigenvalue accounts for 8.19% of the total variance, while the eigenvalue of row two only accounts for 6.17%. The rightmost column cumulates the variance captured to that point. The system outputs eigenvalues in descending size.

The system will output a large number of eigenvalues, raising the question how many should be carried forward for analysis. Clearly, the eigenvalue of row 20, accounting for only some 3% of variance, would seem to be superfluous.

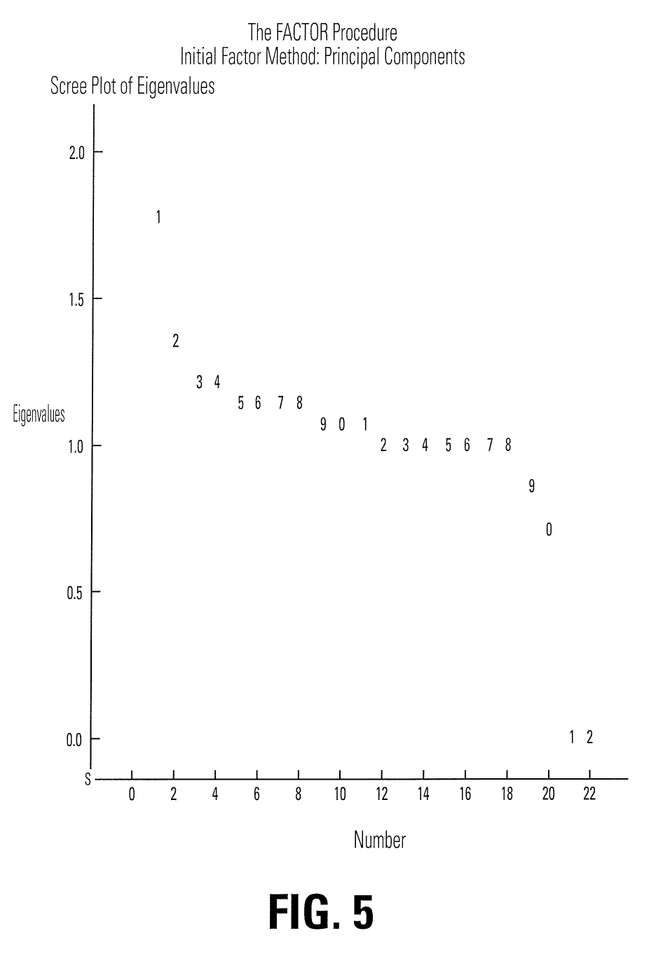

An analytical tool for looking at that question graphically is the scree plot, shown in FIG. 5. This plot simply sets eigenvalue number vs. value quantity on the two axes. A typical scree plot has an initial section of steep slope, followed by a curved transition section and a flattening tail. The slope corresponds to the difference in adjacent eigenvalues, and thus it indicates the relative contribution being made by each additional eigenvalue carried forward in the analysis. One evaluates the added value of additional eigenvalues, together with the cumulative variance captured to that point. Here, the portion after eigenvalue 5 is fairly flat, but owing to the relatively small amount of variance captured in the first eigenvalue (around 8%), some value is seen in stretching out the process. Here, it was decided to include 9 eigenvalues, which carries the cumulative variance to over 50%. Based on that decision, the software will proceed to extract and work with nine factors in the remainder of the analysis.

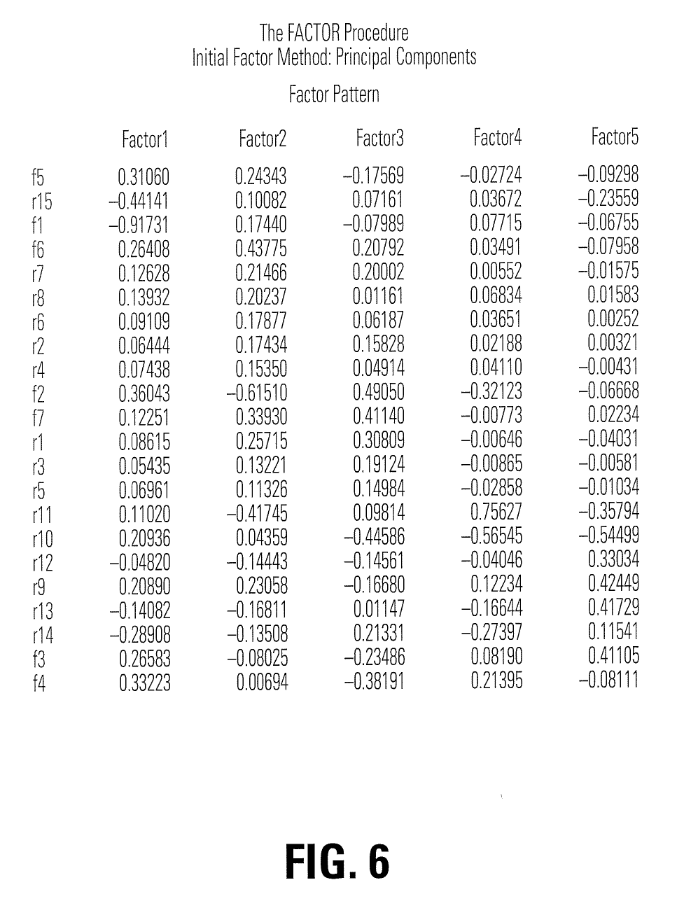

Next, the software extracts factors, as shown in FIG. 6. This figure only illustrates a portion of the software output, which would continue with further listings of a separate column for each factor. The columns are the eigenvectors, with the entire output constituting a matrix of nine columns and 22 rows.

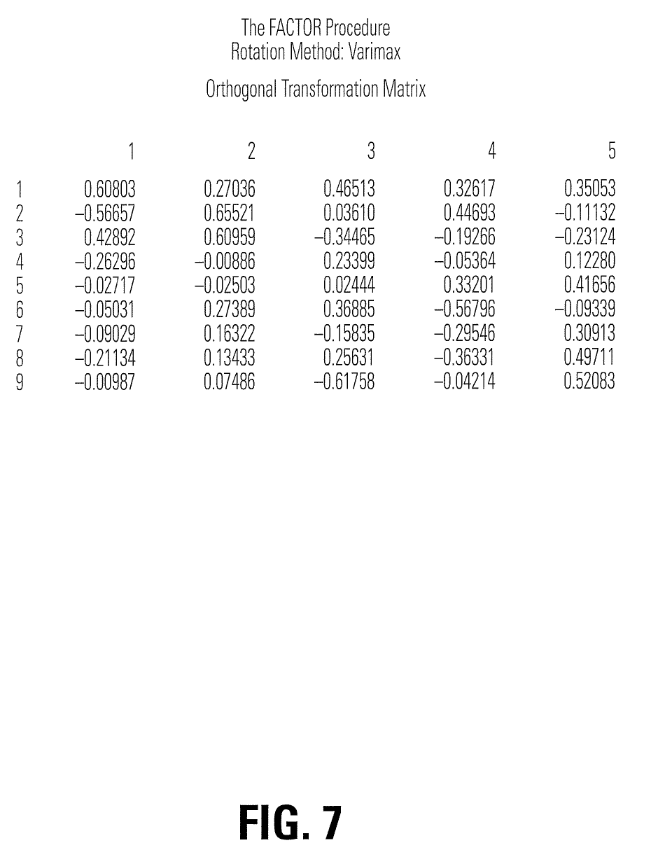

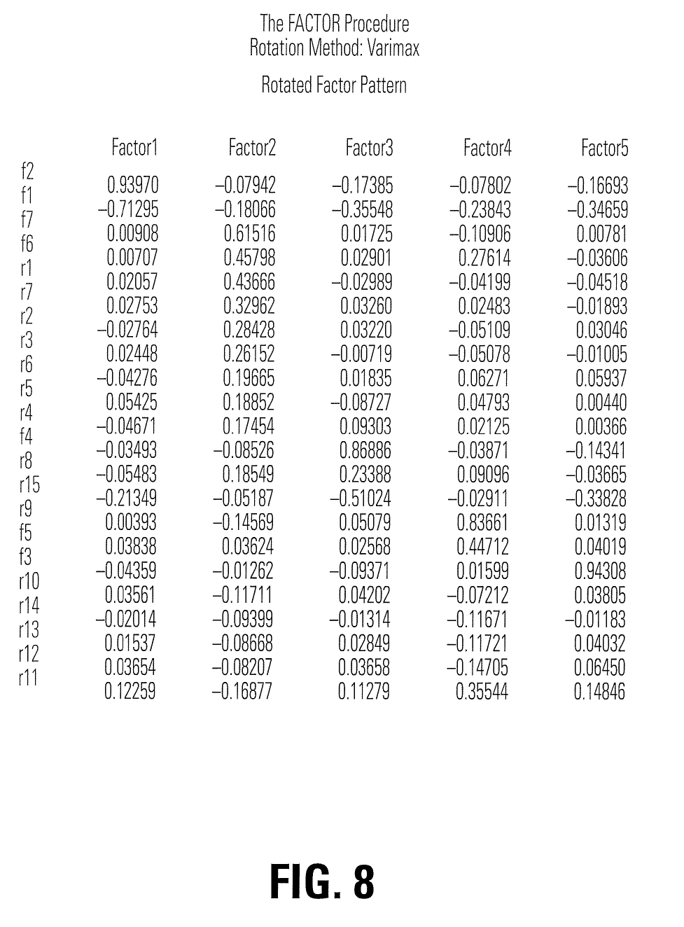

As noted above, a central feature of principal component analysis is not only identification of factors but rotation of axes to arrive at a rotated factor matrix, providing the best fit of the multidimensional space to the data. That step requires an orthogonal transformation matrix, partially seen at FIG. 7. That matrix is multiplied with the factor matrix to produce the rotated factor matrix of FIG. 8. As known in the art, different rotation schemes can be used, both orthogonal and oblique. Here it is preferred to employ an orthogonal rotation, using a standard varimax algorithm. Those in the art will understand the use of other rotations, such as the oblique promax, to accomplish different results. For those requiring additional information, the SAS documentation on this technique should serve as a good beginning point.

Each of the columns of FIG. 8 thus represents a vector, and the set of nine such vectors represents one output from the training process. This set of vectors can be multiplied by input data to produce a set of orthogonal values.

The remaining major training step is to employ the rotated vector set to estimate the probability that a user will actually click on a given banner advertisement. This step employs another function of the SAS analytical software, the LOGISTIC routine. Here, the task is akin to that faced in linear regressions, with the important exception that the dependent variable is not continuous but rather is binary—a click will either happen or not. That factor, as those in the art will be aware, requires the use of a logistic rather than linear regression. In preparing for this operation, the output matrix shown in FIG. 8 is re-run in the FACTOR routine to produce a scoring output (not shown), which is required as input for the LOGISTIC routine. Also, the LOGISTIC routine is run using the stepwise option, so that at each calculating step the system will use the variable that has the strongest effect on the result.

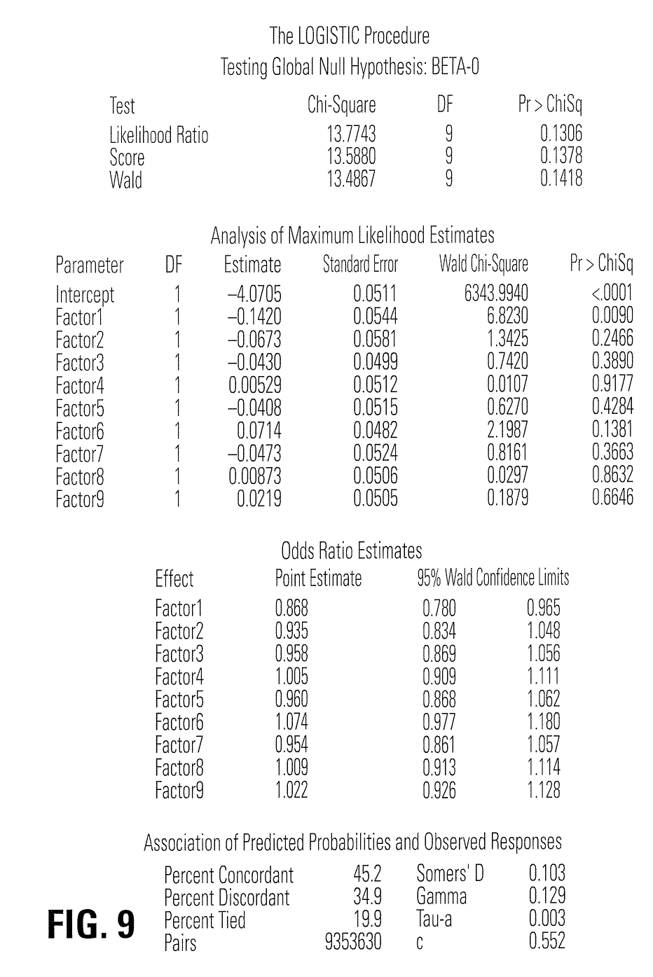

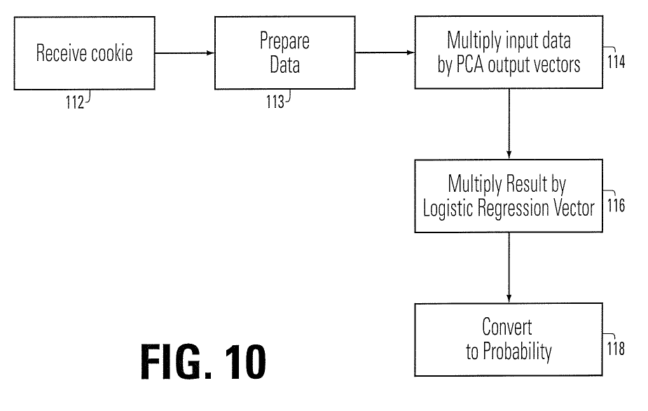

FIG. 9 shows the output of the logistic regression step. For each factor, the system calculates an estimate, a standard error, and a chi-squared independence test. There is also calculated a set of odds ratio estimates for each factor.

The “Estimate” column is the critical output of this step, as that column provides an intercept (the first figure in the column) and a 1×9 vector that can be used to transform the output from the principal components analysis, which in turn produces a linear equation, which in turn can produce a single number, termed the logit of the logistic regression. As known in the art, the logit can be converted to a probability as a result of the relation P=e^{L}/(1+e^{(L))}, where L is the logit.

The application phase, which employs the results of the training phase to deploy actual banner advertisements to actual web users in real time, is depicted in FIG. 10. A cookie, or equivalent data transfer, is received in step 112. This data is structured as shown in Table 1, and it contains user history in terms of recency and frequency information for all categories in which the user has been active. As was done for the training data, this data must be prepared, in step 113. The categories of interest are identified and data is extracted for them, producing a set of input data as shown in Table 2. Here, the analytical work has been done, and thus the input data can be directly multiplied by the PCA output vectors, in step 114, and the output of that step can be multiplied by the logistic regression output vector in step 116. That operation produces a set of coefficients to a linear equation that directly produces a logit, which in turn converts to a probability as set out above.

Iteration of that process for each banner ad in the inventory can proceed rapidly, with the result being a set of click probabilities for the various banner ads. The advertisement with the highest click probability is then shown to the user.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A method of quantifying the propensity of a consumer to respond positively to an advertisement, comprising the steps of:
producing a set of training factors from the entire set of user data available, one set of such factors being associated with each advertisement under study to indicate the probability of positive response to that advertisement;
receiving input data from a user in real time;
applying the training factors to the user data to identify the advertisement having the highest probability of positive response;
displaying the identified advertisement to the user.

2. The method of claim 1, wherein producing the training factors includes the steps of:
gathering data from a large user population concerning user behavior while navigating the internet, including data concerning sites visited, links clicked and time spent per site;
selecting a subset of data for analysis, consisting of data related to a single banner advertisement;
removing outlier data from the dataset;
performing a primary components analysis to identify a set of eigenvectors and eigenvalues;
rotating the dataset axes by employing an orthogonal transformation matrix;
determining specific probabilities of action through a stepwise logistic regression.

3. The method of claim 2, wherein removing outlier data includes applying a k-means cluster algorithm to the dataset.
